(19) United States
(12) Patent Application Publication
(10) Pub. No.: US 2024/0348115 A1
(43) Pub. Date: Oct. 17, 2024

(54) ROTOR, MOTOR, COMPRESSOR, AND REFRIGERATION CYCLE APPARATUS

(71) Applicant: Mitsubishi Electric Corporation, Tokyo (JP)

(72) Inventors: Hiroki IWATA, Tokyo (JP); Tomoki MASUKO, Tokyo (JP); Atsushi MATSUOKA, Tokyo (JP)

(21) Appl. No.: 18/682,196

(22) PCT Filed: Sep. 8, 2021
(86) PCT No.: PCT/JP2021/032986

§ 371 Date: Feb. 8, 2024

(51) Int. Cl. H02K 1/276; F25B 31/02; H02K 21/14

(52) U.S. Cl. CPC H02K 1/276; F25B 31/026; H02K 21/14; H02K 2213/03

(57) ABSTRACT

A rotor core has a magnet insertion hole. The magnet insertion hole has a first hole portion located at a center thereof, and two second hole portions extending from both ends of the first hole portion toward the outer circumference of the rotor core. A first permanent magnet is disposed in the first hole portion, and a second permanent magnet is disposed in each second hole portion. The rotor core has a first slit formed between each second hole portion and the magnetic pole center line and having a length in the circumferential direction, and a second slit formed between the first slit and the magnetic pole center line and having a length in the radial direction. The shortest distance C [mm] from the first slit to the magnet insertion hole and the shortest distance S [mm] from the first slit to the outer circumference satisfy S≤−0.7517 C²+0.2021 C+1.1395.

### CROSS-REFERENCE TO RELATED APPLICATION

This application is a U.S. National Stage Application of PCT/JP2021/032986 filed Sep. 8, 2021, the contents of which are incorporated herein by reference.

### TECHNICAL FIELD

The present disclosure relates to a rotor, a motor, a compressor, and a refrigeration cycle apparatus.

### BACKGROUND

A permanent magnet embedded rotor has a rotor core having a magnet insertion hole and a permanent magnet disposed in the magnet insertion hole. The permanent magnet has a flat plate shape and is magnetized in its thickness direction. Two or more permanent magnets may be disposed in one magnet insertion hole. For example, two permanent magnets may be disposed in a V-shaped magnet insertion hole.

As the surface area of the permanent magnet increases, the magnetic flux generated therefrom increases, which leads to an improvement in motor output. In recent years, a rotor has been proposed in which three permanent magnets are disposed in the magnet insertion hole in order to increase the surface area of the permanent magnets. Three permanent magnets are arranged in such a manner that two permanent magnets thereof are placed obliquely on both sides on the center permanent magnet to face each other. Such an arrangement is also referred to as a bathtub-shaped arrangement.

On the other hand, a rotor has also been proposed in which slits elongated in the circumferential direction are formed adjacent to the ends of a V-shaped magnet insertion hole in order to collect magnetic flux emitted from the permanent magnets toward the pole center (see, for example, Patent Reference 1).

### PATENT REFERENCE

Patent Reference 1: International Publication No. WO 2017/203618 (see FIG. 2)

However, when three permanent magnets are disposed in one magnet insertion hole, the directions of the magnetic flux flowing into the ends of the permanent magnets closest to the outer circumference of the rotor core are made closer to the thickness directions of the permanent magnets (i.e., the magnetization direction). Consequently, demagnetization of the permanent magnets cannot be sufficiently suppressed only by providing the slits described above.

### SUMMARY

The present disclosure is made to solve the above problem, and an object of the present disclosure is to suppress the demagnetization of a permanent magnet.

A rotor of the present disclosure includes a rotor core having an outer circumference extending in a circumferential direction about an axis and a magnet insertion hole disposed on an inner side of the outer circumference in a radial direction about the axis, and at least three permanent magnets disposed in the magnet insertion hole. The magnet insertion hole has a first hole portion located at a center of the magnet insertion hole in the circumferential direction, and two second hole portions extending from both ends of the first hole portion in the circumferential direction toward the outer circumference. The at least three permanent magnets include a first permanent magnet disposed in the first hole portion and a second permanent magnet disposed in each of the second hole portions. The first hole portion extends in a direction perpendicular to a magnetic pole center line that extends in the radial direction and passes through a center of the magnet insertion hole in the circumferential direction. The rotor core has a first slit formed between each of the second hole portions and the magnetic pole center line and having a length in the circumferential direction, and a second slit formed between the first slit and the magnetic pole center line and having a length in the radial direction. A shortest distance C [mm] from the first slit to the magnet insertion hole and a shortest distance S [mm] from the first slit to the outer circumference satisfy S≤−0.7517 C²+0.2021 C+1.1395.

According to the present disclosure, the amount of magnetic flux passing through a corner of the second permanent magnet on the outer circumferential side can be reduced, and thus demagnetization of the second permanent magnet can be suppressed.

### BRIEF DESCRIPTION OF THE DRAWINGS

FIG. 1 is a sectional view illustrating a motor of a first embodiment.

FIG. 2 is a sectional view illustrating a rotor of the first embodiment.

FIG. 3 is an enlarged sectional view illustrating a part of the rotor of the first embodiment.

FIG. 4 is an enlarged sectional view illustrating a region corresponding to one magnetic pole of the rotor of the first embodiment.

FIG. 5 is a schematic diagram illustrating the flow of magnetic flux in a rotor core of Comparative Example.

FIG. 6 is a graph illustrating the relationship between a stator current and the demagnetization rate of a permanent magnet.

FIGS. 7(A) and 7(B) are schematic diagrams illustrating the flows of magnetic flux in rotor cores in Comparative Example and the first embodiment, respectively.

FIG. 8 is an enlarged sectional view illustrating a portion including a magnet insertion hole and a side slit in the rotor of the first embodiment.

FIGS. 9(A) and 9(B) are graphs illustrating the relationship between a shortest distance S from the side slit to an outer circumference of the rotor core and the demagnetization rate.

FIGS. 10(A) and 10(B) are graphs illustrating the relationship between the shortest distance S from the side slit to the outer circumference of the rotor core and the demagnetization rate.

FIG. 11 is a graph illustrating the relationship between the shortest distance S from the side slit to the outer circumference of the rotor core and a shortest distance C from the side slit to the magnet insertion hole.

FIG. 12 is a graph illustrating the relationship between the ratio of a length L2 of a slit to a length L1 of the side slit and the demagnetization rate.

FIG. 13 is an enlarged sectional view illustrating a part of a rotor of a second embodiment.

FIG. 14 is a table showing the relationship between the ratio of a shortest distance B from a magnetic pole center line to a slit to a width W1 of the permanent magnet and the rate of reduction in induced voltage.

FIG. 15 is an enlarged sectional view illustrating a part of a rotor of a third embodiment.

FIG. 16 is an enlarged sectional view illustrating a region corresponding to one magnetic pole of the rotor of the third embodiment.

FIG. 17 is a graph illustrating the relationship between a Vf ratio and an angle formed between an end edge of a slit and a straight line passing through an inner end point of the end edge in the radial direction and a point of a side slit on the pole center side.

FIG. 18 is a sectional view illustrating a compressor to which a motor of each embodiment is applicable.

FIG. 19 is a diagram illustrating a refrigeration cycle apparatus including a compressor illustrated in FIG. 18.

### DETAILED DESCRIPTION

### First Embodiment

### (Configuration of Motor)

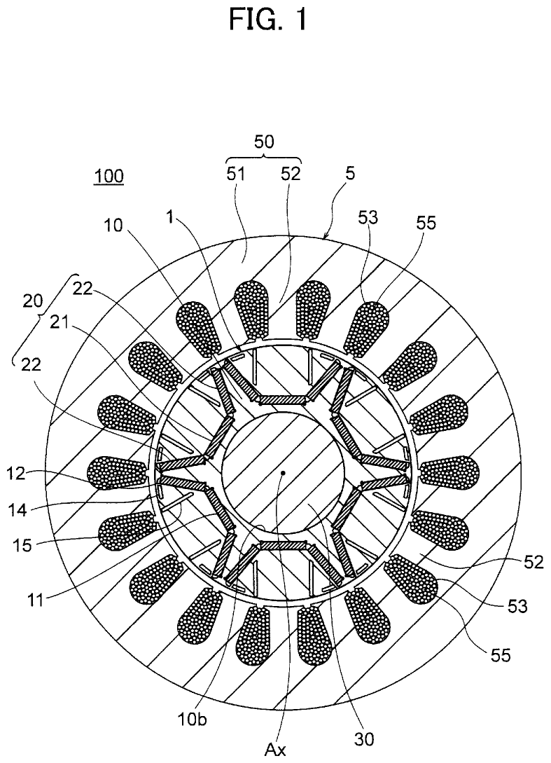

First, a motor 100 of a first embodiment will be described. FIG. 1 is a cross-sectional view illustrating the motor 100 of the first embodiment. The motor 100 is a permanent magnet embedded motor that has permanent magnets 20 embedded in a rotor 1.

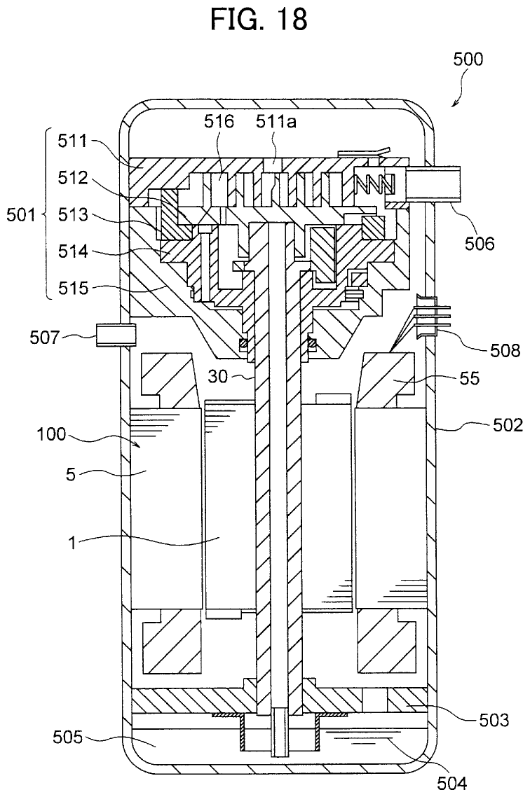

The motor 100 has the rotor 1 that is rotatable and a stator 5 provided to surround the rotor 1. An air gap of, for example, 0.3 to 1.0 mm is formed between the stator 5 and the rotor 1. The stator 5 is fixed inside a hermetic container 502 (FIG. 18) of a compressor 500 to be described later.

Hereinafter, the direction of an axis Ax, which is a rotation axis of the rotor 1, is referred to as an “axial direction”. The circumferential direction about the axis Ax is referred to as a “circumferential direction”. The radial direction about the axis Ax is referred to as a “radial direction”.

### (Configuration of Stator)

The stator 5 has a stator core 50 and coils 55 wound on the stator core 50. The stator core 50 is formed of electromagnetic steel sheets, which are stacked in the axial direction and fixed together by crimping or the like. Each electromagnetic steel sheet has a sheet thickness of, for example, 0.1 to 0.7 mm. The stator core 50 has a yoke 51 having an annular shape about the axis Ax and a plurality of teeth 52 extending inward in the radial direction from the yoke 51.

The teeth 52 are formed at equal intervals in the circumferential direction. The number of teeth 52 is 18 in this example, but only needs to be two or more. A slot 53, which serves to house the coil 55, is formed between adjacent teeth 52. An insulating portion made of a resin, such as polyethylene terephthalate (PET), is provided between the slot 53 and the coil 55.

The coil 55 is formed of a magnet wire and wound around the tooth 52 by concentrated winding or distributed winding. The coil 55 has a wire diameter of, for example, 0.8 mm. The coils 55 have winding portions of three phases, namely, U, V and W phases, and are connected in Y-connection or delta-connection.

### (Configuration of Rotor)

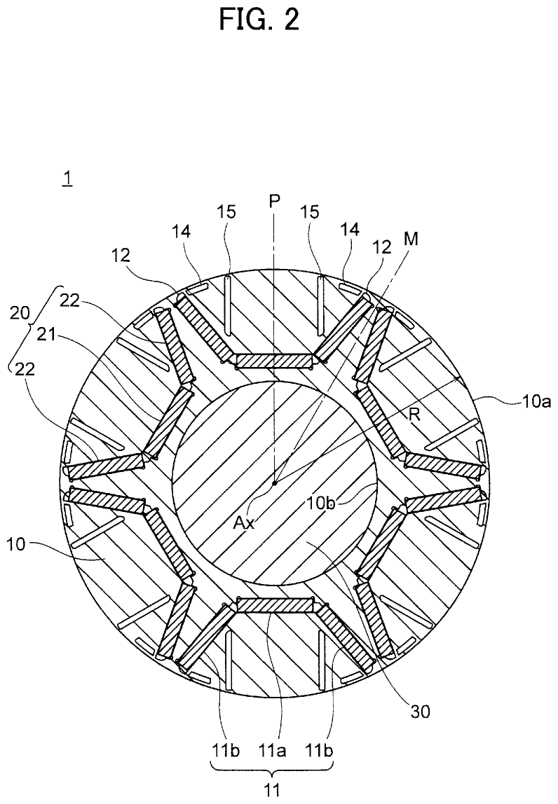

FIG. 2 is a sectional view illustrating the rotor 1. The rotor 1 has a rotor core 10 of a cylindrical shape, the permanent magnets 20 attached to the rotor core 10, and a shaft 30 fixed at the center of the rotor core 10. The center axis of the shaft 30 coincides with the axis Ax described above. The rotor core 10 has an outer circumference 10a and an inner circumference 10b. Each of the outer and inner circumferences 10a and 10b is circular about the axis Ax.

The rotor core 10 is formed of electromagnetic steel sheets, which are stacked in the axial direction and integrated together by crimping or the like. Each electromagnetic steel sheet has a sheet thickness of, for example, 0.1 to 0.7 mm, and is 0.35 mm in this example. The shaft 30 is fixed to the inner circumference 10b of the rotor core 10 by shrink-fitting or press-fitting.

A plurality of magnet insertion holes 11 are formed along the outer circumference 10a of the rotor core 10. The plurality of magnet insertion holes 11 are formed at equal intervals in the circumferential direction. Each magnet insertion hole 11 extends from one end to the other end of the rotor core 10 in the axial direction.

One magnet insertion hole 11 corresponds to one magnetic pole. The number of magnet insertion holes 11 is six in this example, and therefore the number of poles is six. However, the number of poles is not limited to six, but only needs to be two or more. An inter-pole portion M is formed between adjacent magnetic poles, i.e., adjacent magnet insertion holes 11.

Three permanent magnets 20 are disposed in each magnet insertion hole 11. The three permanent magnets 20 include one permanent magnet 21 as a first permanent magnet located at the center in the circumferential direction and two permanent magnets 22 as second permanent magnets located on both sides of the permanent magnet 21. Each of the permanent magnets 21 and 22 is formed of a rare earth magnet that contains, for example, neodymium (Nd), iron (Fe), and boron (B).

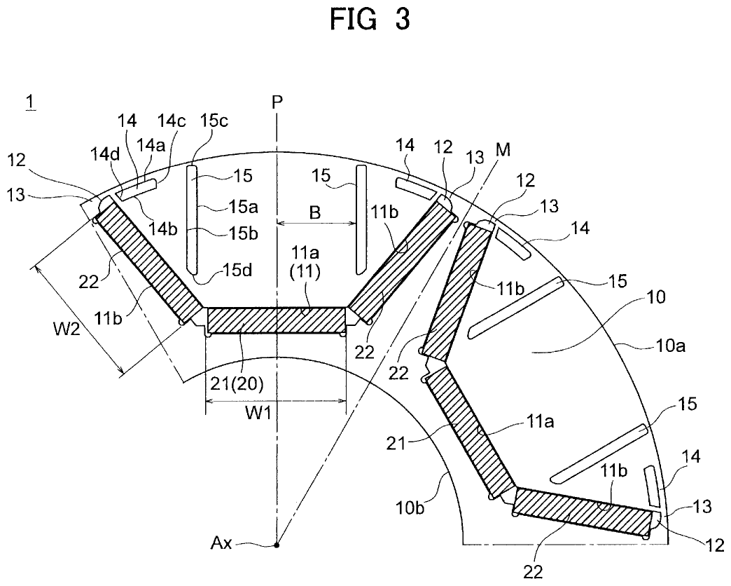

FIG. 3 is a diagram illustrating a part of the rotor 1, more specifically, a region corresponding to two magnetic poles. The center of the magnet insertion hole 11 in the circumferential direction corresponds to a pole center. A straight line in the radial direction that passes through the pole center is referred to as a magnetic pole center line P.

The magnet insertion hole 11 has a first hole portion 11a located at the center thereof in the circumferential direction, and two second hole portions 11b located on both sides of the first hole portion 11a in the circumferential direction. The first hole portion 11a of the magnet insertion hole 11 extends in a direction perpendicular to the magnetic pole center line P.

Each second hole portion 11b of the magnet insertion hole 11 extends from the end of the first hole portion 11a in the longitudinal direction toward the outer circumference 10a. Each second hole portion 11b extends while being inclined with respect to the magnetic pole center line P in such a manner that the distance from the magnetic pole center line P increases toward the outer side in the radial direction. The angle formed between the first hole portion 11a and the second hole portion 11b is, for example, 120 degrees, but is not limited thereto.

The permanent magnet 21 is disposed in the first hole portion 11a of the magnet insertion hole 11. Each of the permanent magnets 22 is disposed in a corresponding one of the two second hole portions 11b. Thus, the permanent magnets 22 on both sides of the center permanent magnet 21 are arranged while being inclined with respect to the permanent magnet 21. Such an arrangement of the permanent magnet 21 and the two permanent magnets 22 is referred to as the bathtub-shaped arrangement.

The permanent magnet 21 has a width W1 in a direction perpendicular to the magnetic pole center line P and a thickness in the direction of the magnetic pole center line P. Each permanent magnet 22 has a width W2 in a direction inclined with respect to the magnetic pole center line P and a thickness in a direction perpendicular to its width direction.

The width W1 of the permanent magnet 21 is the same as the width W2 of each permanent magnet 22 (W1=W2). The thickness of the permanent magnet 21 is the same as the thickness of each permanent magnet 22. That is, the permanent magnet 21 and each permanent magnet 22 have the same shape and dimensions. As an example, the width W1 of the permanent magnet 21 is 20 mm, and the thickness of the permanent magnet 21 is 2 mm. The same goes for the width W2 and the thickness of each permanent magnet 22.

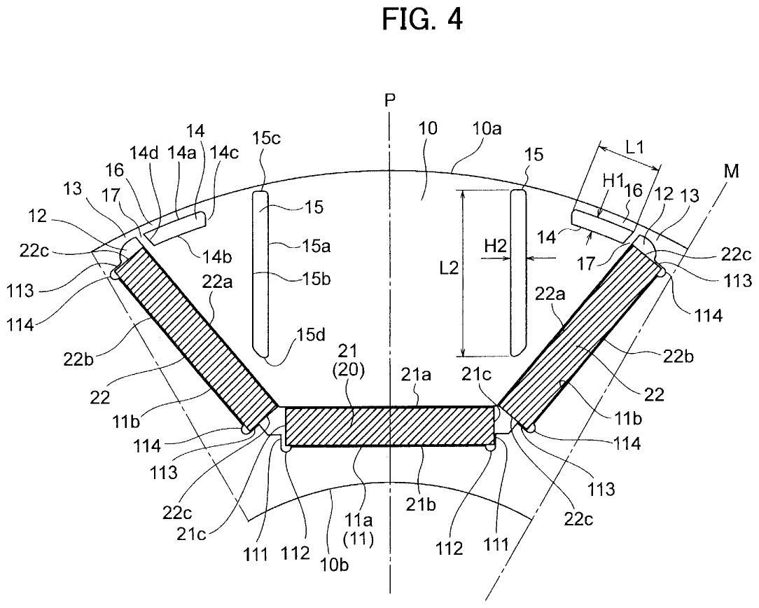

FIG. 4 is an enlarged diagram illustrating a part corresponding to one magnetic pole of the rotor 1. The permanent magnet 21 has an outer-side surface 21a on the outer circumference 10a side, an inner-side surface 21b on the inner circumference 10b side, and end surfaces 21c at both ends thereof in the width direction. The width W1 described above is a distance between the two end surfaces 21c.

Each permanent magnet 22 has an outer-side surface 22a on the magnetic pole center line P side, an inner-side surface 22b on the inter-pole portion M side, and end surfaces 22c at both ends thereof in the width direction. The width W2 described above is a distance between the two end surfaces 22c.

The first hole portion 11a of the magnet insertion hole 11 is provided with two positioning portions 111 which contact both end surfaces 21c of the permanent magnet 21. Each positioning portion 111 is a convex portion protruding from the edge of the first hole portion 11a on the inner circumference 10b side.

The first hole portion 11a is provided with concave portions 112 each of which is adjacent to a corresponding one of the two positioning portions 111 and which face the inner-side surface 21b of the permanent magnet 21. The concave portions 112 are formed to facilitate the processing of the positioning portions 111 and to reduce stress concentration.

Each second hole portion 11b of the magnet insertion hole 11 is provided with two positioning portions 113 that contact both end surfaces 22c of the permanent magnet 22. Each positioning portion 113 is a convex portion protruding from the edge of the second hole portion 11b on the inter-pole portion M side.

Each of the second hole portions 11b is provided with concave portions 114 each of which is adjacent to a corresponding one of the two positioning portions 113 and which face the inner-side surface 22b of the permanent magnet 22. The concave portions 114 are formed to facilitate the processing of the positioning portions 113 and to reduce stress concentration.

The magnet insertion hole 11 has a flux barrier 12 on the outer circumference 10a side of each second hole portion 11b. The flux barrier 12 is an opening to reduce magnetic flux leakage between adjacent magnetic poles. A thin-walled portion 13 is formed between the flux barrier 12 and the outer circumference 10a of the rotor core 10. The width of the thin-walled portion 13 in the radial direction is desirably the same as the sheet thickness of each of the electromagnetic steel sheets that constitute the rotor core 10.

A side slit 14 is formed between the magnet insertion hole 11 and the magnetic pole center line P, more specifically between the flux barrier 12 and the magnetic pole center line P. The side slit 14 extends in the circumferential direction along the outer circumference 10a of the rotor core 10. The side slit 14 has a length L1 in the circumferential direction and a width H1 in the radial direction. The length L1 is longer than the width H1. The side slit 14 is also referred to as a first slit or a circumferential slit.

The side slit 14 has an end edge 14a facing the outer circumference 10a of the rotor core 10, an end edge 14b opposite thereto, an end edge 14c facing the magnetic pole center line P, and an end edge 14d facing the magnet insertion hole 11.

A thin-walled portion 16 is formed between the end edge 14a of the side slit 14 and the outer circumference 10a of the rotor core 10. A thin-walled portion 17 is formed between the end edge 14d of the side slit 14 and the magnet insertion hole 11. The end edge 14d of the side slit 14 faces the flux barrier 12 in this example, but only needs to face the magnet insertion hole 11.

A slit 15 is formed between each side slit 14 and the magnetic pole center line P. Each slit 15 extends parallel to the magnetic pole center line P. The slit 15 has a length L2 in the radial direction and a width H2 in the circumferential direction. The length L2 is longer than the width H2. The slit 15 is also referred to as a second slit or a radial slit.

The slit 15 has an end edge 15a facing the magnetic pole center line P, an end edge 15b opposite thereto, an end edge 15c on the outer side in the radial direction, and an end edge 15d on the inner side in the radial direction. The end edge 15c faces the outer circumference 10a of the rotor core 10, and the end edge 15d faces the second hole portion 11b of the magnet insertion hole 11.

A thin-walled portion having the width in the radial direction that is the same as the sheet thickness of the electromagnetic steel sheet is desirably formed between the end edge 15c of the slit 15 and the outer circumference 10a of the rotor core 10. A thin-walled portion having the width in the radial direction that is the same as the sheet thickness of the electromagnetic steel sheet is also desirably formed between the slit 15 and the magnet insertion hole 11.

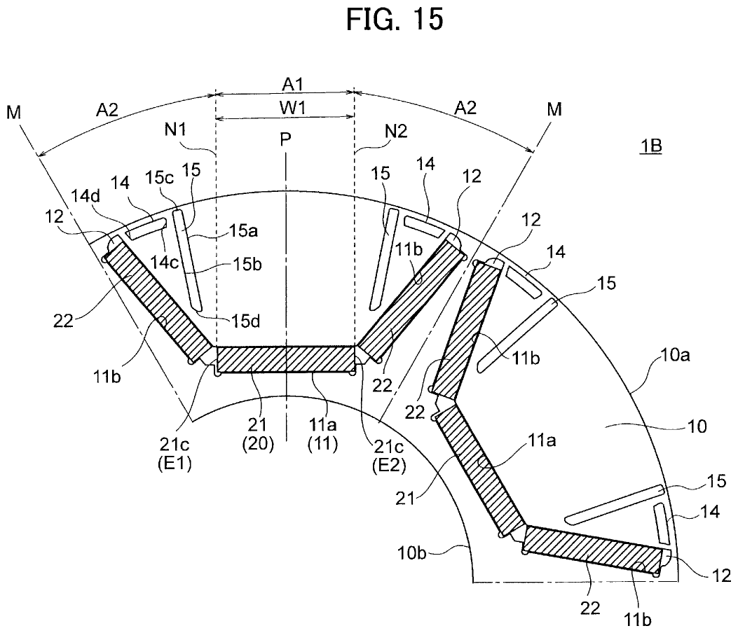

The slit 15 extends parallel to the magnetic pole center line P in this example, but may be inclined with respect to the magnetic pole center line P. In such a case, the slit 15 is desirably inclined in such a manner that the distance from the magnetic pole center line P increases toward the outer side in the radial direction (see FIG. 15 to be described later).

### (Configuration for Suppressing Demagnetization)

Next, a description will be given on the configuration for suppressing demagnetization of the permanent magnets 22 in the first embodiment. The magnetic flux generated by the current flowing through the coils 55 of the stator 5 is referred to as a stator magnetic flux. The stator magnetic flux flows from the teeth 52 of the stator 5 into the rotor core 10.

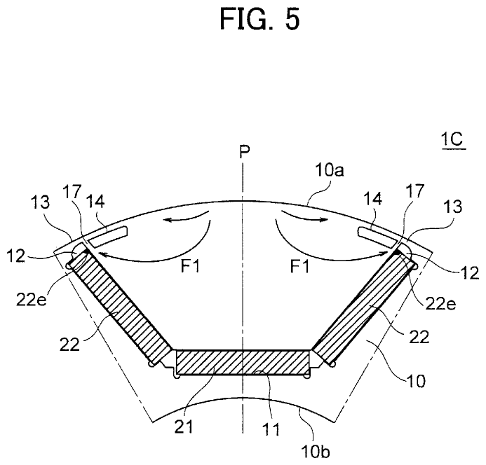

FIG. 5 is a schematic diagram illustrating the flow of magnetic flux in a rotor 1C of Comparative Example having no slit 15. The rotor 1C of Comparative Example has the permanent magnets 21 and 22 arranged in the magnet insertion hole 11 in a bathtub shape, as in the rotor 1 of the first embodiment.

When the permanent magnets 21 and 22 are arranged in the bathtub shape, magnetic flux tends to flow into a corner 22e of the permanent magnet 22 on the outer circumference 10a side at an angle that is close to being parallel to the magnetization direction (i.e., the thickness direction) of the permanent magnet 22.

In particular, the rotor 1C of Comparative Example is provided with side slits 14 to rectify the magnetic flux of the permanent magnets 21 and 22 toward the pole center. Thus, part of the stator magnetic flux passes through the thin-walled portion 17 between the side slit 14 and the magnet insertion hole 11 and is directed toward the outer circumference 10a of the rotor core 10, as indicated by arrow F1 in FIG. 5.

When the magnetic flux passes through the thin-walled portion 17 between the side slit 14 and the magnet insertion hole 11 in this way, part of the magnetic flux also flows to the corner 22e on the outer circumference 10a side of the permanent magnet 22 and on the side slit 14 side. As a result, the demagnetization at the corner 22e of the permanent magnet 22 may occur.

In order to suppress demagnetization of the permanent magnet 22, it is conceivable to increase the thickness of the permanent magnet 22. However, since the permanent magnet 22 is formed of a high-cost rare earth magnet, an increase in the thickness of the permanent magnet 22 leads to an increase in manufacturing cost.

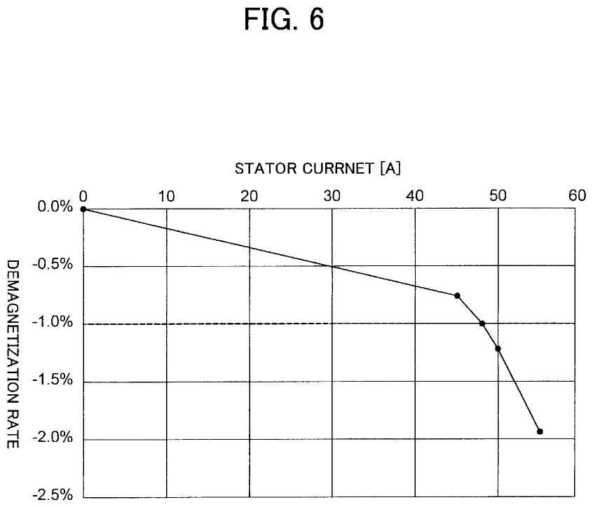

FIG. 6 is a graph showing the relationship between a stator current and the demagnetization rate of the permanent magnet 22 in a motor including the rotor 1C of Comparative Example. The horizontal axis indicates the stator current, and the vertical axis indicates the demagnetization rate. The stator current is a current flowing through the coil 55 of the stator 5. The demagnetization rate D is determined from the following equation (1) based on the magnetic flux φfₚᵣₑ [Wb] before the demagnetization of the permanent magnet 22 and the magnetic flux φf_{aft} [Wb] after the demagnetization of the permanent magnet 22.

$$[ Equation 1 ]$$

$$D = ( \frac{ϕ {f}_{aft}}{ϕ {f}_{pre}} - 1 ) \times 100 \qquad ( 1 )$$

As illustrated in FIG. 6, the demagnetization rate reaches-1% when the stator current reaches 48 A (amperes), and the demagnetization progresses further as the stator current increases more. The current value at which the demagnetization rate reaches −1% is referred to as a reference current.

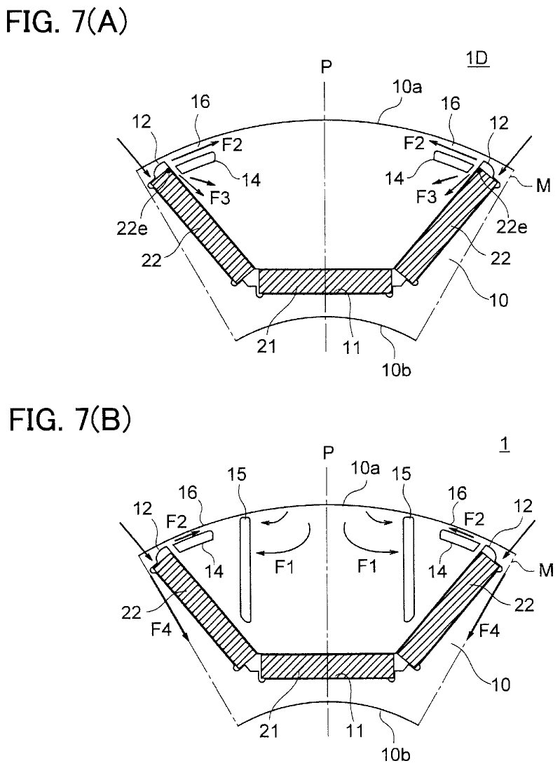

In order to reduce the flow of magnetic flux to the corner 22e of the permanent magnet 22, it is conceivable to dispose the side slit 14 on the inner side in the radial direction with respect to the flux barrier 12, as in a rotor 1D illustrated in FIG. 7(A).

In the rotor 1D, the width in the radial direction of the thin-walled portion 16 between the side slit 14 and the outer circumference 10a of the rotor core 10 is widened. Thus, the magnetic flux flowing from the stator core 50 into the inter-pole portion M of the rotor core 10 is likely to flow along the outer circumference 10a of the rotor core 10 through the thin-walled portion 16 as indicated by arrow F2, instead of flowing inward in the radial direction through the inter-pole portion M.

When the flow of the magnetic flux is generated from the inter-pole portion M along the outer circumference 10a of the rotor core 10 in this way, the flow of magnetic flux is also generated to pass through the corner 22e of the permanent magnet 22 as indicated by arrow F3, which may cause demagnetization at the corner 22e.

For this reason, in the first embodiment, the slit 15 is formed between the side slit 14 and the magnetic pole center line P as illustrated in FIG. 7(B). Thus, the slit 15 can block the flow of magnetic flux from the pole center side toward the corner 22e of the permanent magnet 22 as indicated by arrow F1. As a result, the demagnetization of the permanent magnet 22 can be suppressed.

With this arrangement, the width in the radial direction of the thin-walled portion 16 between the side slit 14 and the outer circumference 10a of the rotor core 10 can be narrowed. Thus, the magnetic flux flowing from the stator core 50 into the inter-pole portion M of the rotor core 10 is likely to flow inward in the radial direction as indicated by arrow F4. As a result, the flow of the magnetic flux along the outer circumference 10a of the rotor core 10 is reduced, and thus demagnetization of the permanent magnet 22 such as that in the case illustrated in FIG. 7(A) can be suppressed.

Next, a description will be given on a shortest distance C from the side slit 14 to the magnet insertion hole 11 and a shortest distance S from the side slit 14 to the outer circumference 10a of the rotor core 10.

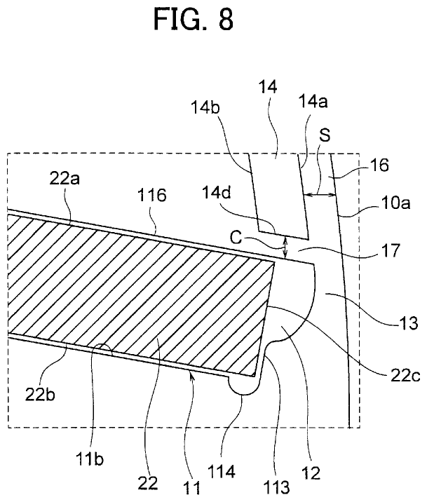

FIG. 8 is an enlarged schematic diagram illustrating a portion including the side slit 14 and the magnet insertion hole 11 of the rotor 1. The shortest distance C is the shortest distance from the end edge 14d of the side slit 14 on the magnet insertion hole 11 side to an end edge 116 of the second hole portion 11b of the magnet insertion hole 11 on the side slit 14 side. The shortest distance S is the shortest distance from the end edge 14a of the side slit 14 on the outer circumference 10a side to the outer circumference 10a of the rotor core 10.

The shortest distance C is the minimum width of the thin-walled portion 17 described above, and the shortest distance S is the minimum width of the thin-walled portion 16 described above. The width of the thin-walled portion 17 is constant over the end edge 14d of the side slit 14, but is not necessarily constant. Similarly, the width of the thin-walled portion 16 is constant over the end edge 14a of the side slit 14, but is not necessarily constant.

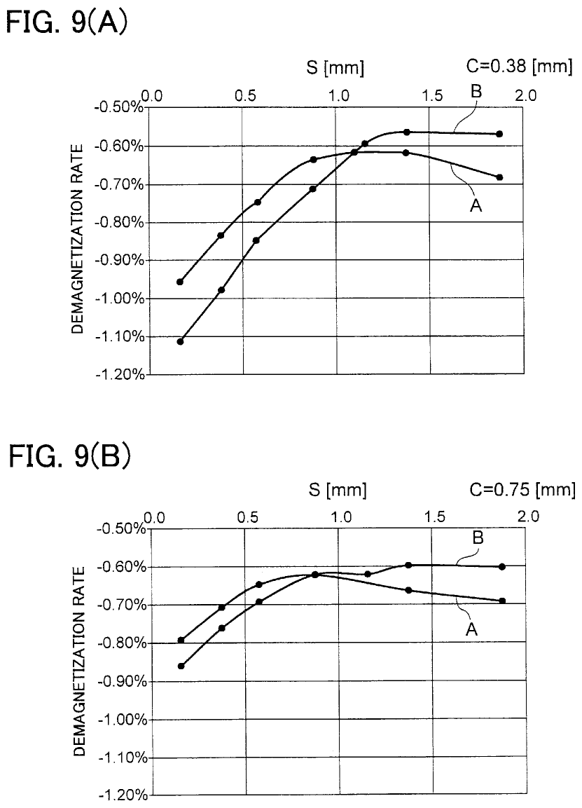

Here, changes in the demagnetization rate when the shortest distance C and the shortest distance S are varied will be described. FIG. 9(A) is a graph showing the relationship between the shortest distance S and the demagnetization rate when the shortest distance C is 0.38 mm. FIG. 9(B) is a graph showing the relationship between the shortest distance S and the demagnetization rate when the shortest distance C is 0.75 mm.

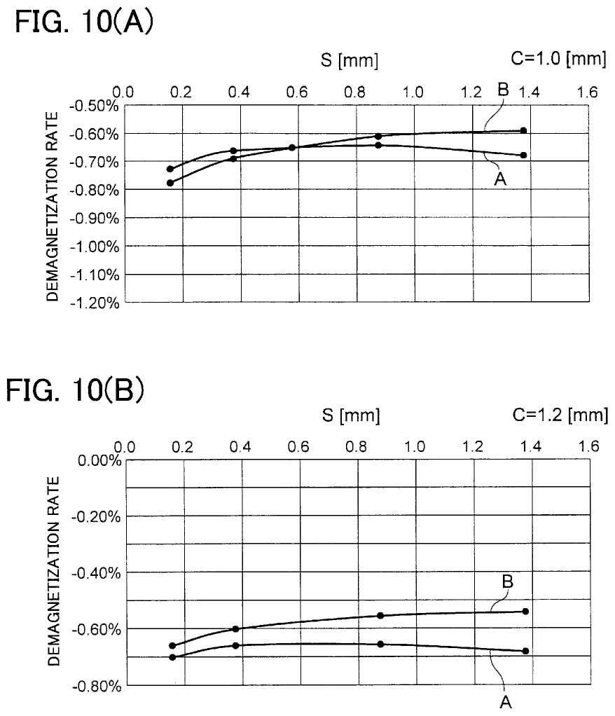

FIG. 10(A) is a graph showing the relationship between the shortest distance S and the demagnetization rate when the shortest distance C is 1.00 mm. FIG. 10(B) is a graph showing the relationship between the shortest distance S and the demagnetization rate when the shortest distance C is 1.20 mm.

In all FIGS. 9(A) to 10(B), the horizontal axis indicates the shortest distance S, and the vertical axis indicates the demagnetization rate. The definition of the demagnetization rate is as described with reference to equation (1). The value of the demagnetization rate is negative. As the absolute value of the demagnetization rate increases, the demagnetization progresses more. The reference current described above is applied to the coils 55 of the stator 5. Reference character A denotes the data on the first embodiment, and reference character B denotes the data on Comparative Example (FIG. 5).

As illustrated in FIG. 9(A), in a case where the shortest distance C is 0.38 mm, the absolute value of the demagnetization rate of the first embodiment is less than or equal to the absolute value of the demagnetization rate of Comparative Example when the shortest distance S is within the range of 1.1 mm or less. In other words, the demagnetization rate is improved over Comparative Example when the shortest distance S is within the range of 1.1 mm or less.

As illustrated in FIG. 9(B), in a case where the shortest distance C is 0.75 mm, the demagnetization rate is improved over Comparative Example when the shortest distance S is within the range of 0.9 mm or less. As illustrated in FIG. 10(A), in a case where the shortest distance C is 1.0 mm, the demagnetization rate is improved over Comparative Example when the shortest distance S is within the range of 0.6 mm or less.

From these results, it is understood that when the shortest distance C is constant, the demagnetization rate is improved more as the shortest distance S decreases.

On the other hand, as illustrated in FIG. 10(B), in a case where the shortest distance C is 1.20 mm, improvement in the demagnetization rate over Comparative Example is not observed. This is considered to be because, in a case where the shortest distance C is 1.20 mm, the width of the thin-walled portion 17 between the side slit 14 and the magnet insertion hole 11 exceeds three times the sheet thickness (for example, 0.35 mm) of the electromagnetic steel sheet, so that the magnetic flux is likely to pass through the thin-walled portion 17, and thus the effect of reducing the amount of magnetic flux flowing through the corner 22e of the permanent magnet 22 cannot be achieved.

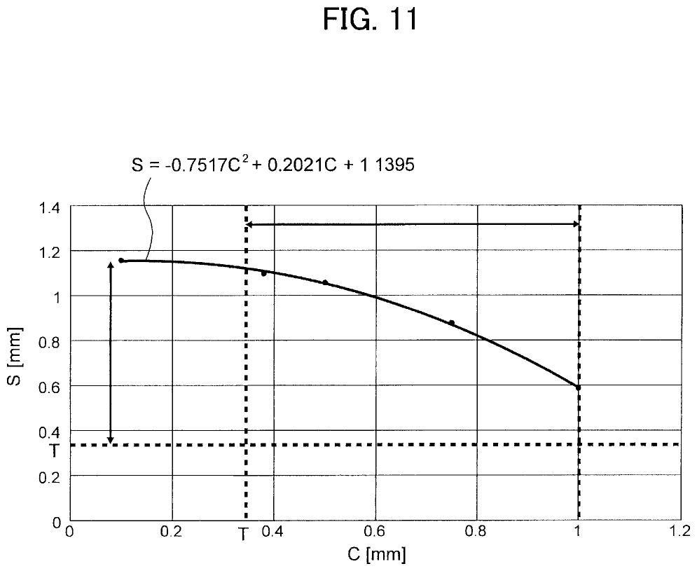

FIG. 11 is a graph of the relationship between the shortest distance C and the shortest distance S at which the demagnetization rate is improved over Comparative Example, the relationship being determined from the results of FIGS. 9(A) to 10(B).

The curve illustrated in FIG. 11 is represented as S=−0.7517 C²+0.2021 C+1.1395. As described above, when the shortest distance C is constant, the demagnetization rate is improved more as the shortest distance S decreases. Thus, the shortest distance C and the shortest distance S desirably satisfy the following equation (2).

$$S \leq - 0.7517 {C}^{2} + 0.2021 C + 1.1395 \qquad ( 2 )$$

That is, the demagnetization of the permanent magnet 22 can be suppressed by forming the side slit 14 and the slit 15 in the rotor core 10 and setting the shortest distance C from the side slit 14 to the magnet insertion hole 11 and the shortest distance S from the side slit 14 to the outer circumference 10a of the rotor core 10 to satisfy equation (2).

With such a configuration, it is not necessary to increase the shortest distance S from the side slit 14 to the outer circumference 10a of the rotor core 10, i.e., the width of the thin-walled portion 16. Thus, the suppression of the demagnetization can be achieved while suppressing the magnetic flux leakage between adjacent magnetic poles.

Due to the restrictions on the processing of the electromagnetic steel sheet, the shortest distance S from the side slit 14 to the outer circumference 10a of the rotor core 10 is desirably greater than or equal to the sheet thickness T of each of the electromagnetic steel sheets that constitute the rotor core 10. Thus, it is more desirable that the shortest distance C and the shortest distance S satisfy the following equation (3). Incidentally, the sheet thickness T is, for example, 0.35 mm.

$$T \leq S \leq - 0.7517 {C}^{2} + 0.2021 C + 1 \text{.1395} \qquad ( 3 )$$

The shortest distance C from the side slit 14 to the magnet insertion hole 11 is desirably greater than or equal to the sheet thickness T of the electromagnetic steel sheet, due to restrictions on the processing of the electromagnetic steel sheet. From the results illustrated in FIG. 11, the shortest distance C is desirably 1.0 mm or less. That is, T and C desirably satisfy T≤C≤1.0.

Next, the relationship between the length L1 of the side slit 14 and the length L2 of the slit 15 will be described. The length L1 of the side slit 14 is its length in the circumferential direction. The length L2 of the slit 15 is its length in the radial direction, more specifically, its length in the direction parallel to the magnetic pole center line P.

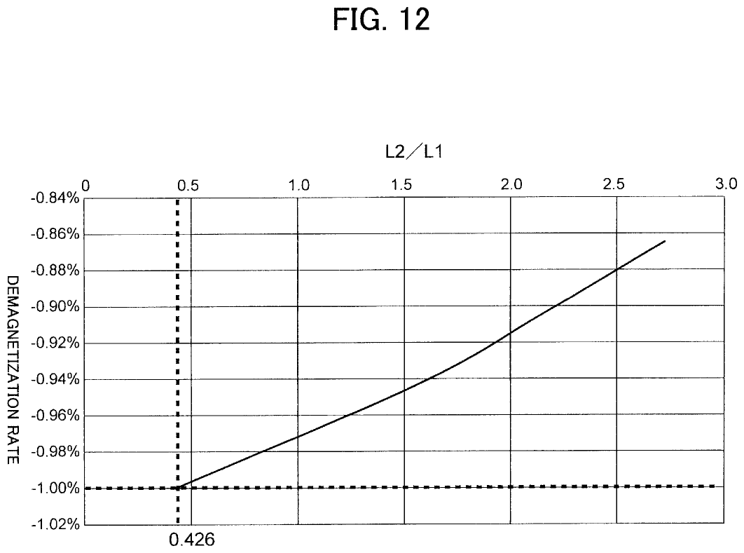

Here, the ratio L2/L1 of the length L2 of the slit 15 to the length L1 of the side slit 14 is varied, and the resulting changes in the demagnetization rate of the permanent magnet 22 are determined by analysis. FIG. 12 is a graph showing the relationship between the length ratio L2/L1 and the demagnetization rate.

In the analysis, the length L1 of the side slit 14 is set constant, whereas the length L2 of the slit 15 is varied. The length L2 of the slit 15 is varied by changing the position of the inner end of the slit 15 in the radial direction while setting an interval between the outer end of the slit 15 in the radial direction and the outer circumference 10a of the rotor core 10 constant (here, corresponding to the sheet thickness T of the electromagnetic steel sheet).

As illustrated in FIG. 12, as the ratio L2/L1 increases, i.e., as the length L2 of the slit 15 increases relative to the length L1 of the side slit 14, the demagnetization rate is improved more. In particular, if the ratio L2/L1 is 0.426 or more, the absolute value of the demagnetization rate can be suppressed to less than 1.0%.

Thus, the ratio L2/L1 of the length L2 of the slit 15 to the length L1 of the side slit 14 is desirably 0.426 or more.

The slit 15 only needs to be disposed between the side slit 14 and the magnetic pole center line P. As illustrated in FIG. 3, the shortest distance B from the magnetic pole center line P to the slit 15 is desirably greater than or equal to half the width W1 of the permanent magnet 21 (i.e., B≥W1×½). This is because the magnetic flux from the permanent magnet 21 toward the stator 5 can be prevented from being blocked by the slit 15.

Although an example has been described in which one permanent magnet 21 is disposed in the first hole portion 11a of the magnet insertion hole 11, while one permanent magnet 22 is disposed in each of the second hole portions 11b, two or more permanent magnets may be disposed in each of the first and second hole portions 11a and 11b. The permanent magnets 21 and 22 have been described as having the same shape and dimensions, but they do not necessarily have the same shape and dimensions.

### Effects of Embodiment

As described above, in the rotor 1 of the first embodiment, the magnet insertion hole 11 has the first hole portion 11a and the two second hole portions 11b, where the permanent magnets 21 and 22 are arranged in the bathtub shape. The side slit 14 that is elongated in the circumferential direction is formed between each second hole portion 11b and the magnetic pole center line P, and the slit 15 that is elongated in the radial direction is formed between the side slit 14 and the magnetic pole center line P. The shortest distance C [mm] from the side slit 14 to the magnet insertion hole 11 and the shortest distance S [mm] from the side slit 14 to the outer circumference 10a of the rotor core 10 satisfy S≤−0.7517 C²+0.2021 C+1.1395.

With this configuration, the magnetic flux flowing through the corner 22e of each permanent magnet 22 can be reduced, thereby suppressing demagnetization of the permanent magnet 22. The width of the thin-walled portion 16 does not need to be widened, so that the effect of suppressing the demagnetization of the permanent magnet 22 can be achieved while suppressing magnetic flux leakage between adjacent magnetic poles.

Since the shortest distance S is greater than or equal to the sheet thickness T of each of the electromagnetic steel sheets constituting the rotor core 10, the effect of suppressing demagnetization of the permanent magnet 22 can be achieved without complicating a manufacturing process of the rotor 1.

By setting the ratio L2/L1 of the length L2 of the slit 15 to the length L1 of the side slit 14 to 0.426 or more, the flow of the magnetic flux toward the corner 22e side of the permanent magnet 22 can be blocked, and the effect of suppressing demagnetization of the permanent magnet 22 can be enhanced.

When the shortest distance B from the magnetic pole center line P to the slit 15 and the width W1 of the permanent magnet 21 satisfy B≥W1×½, the magnetic flux from the permanent magnet 21 toward the stator 5 can be effectively utilized, and thus motor efficiency can be enhanced.

The thin-walled portion having the width in the radial direction that is the same as the sheet thickness T of the electromagnetic steel sheet is formed between the slit 15 and the outer circumference 10a of the rotor core 10. Thus, the magnetic flux flowing from the stator 5 into the rotor core 10 and directed toward the corner 22e side of the permanent magnet 22 can be reduced. Thus, the effect of suppressing demagnetization of the permanent magnet 22 can be enhanced.

### Second Embodiment

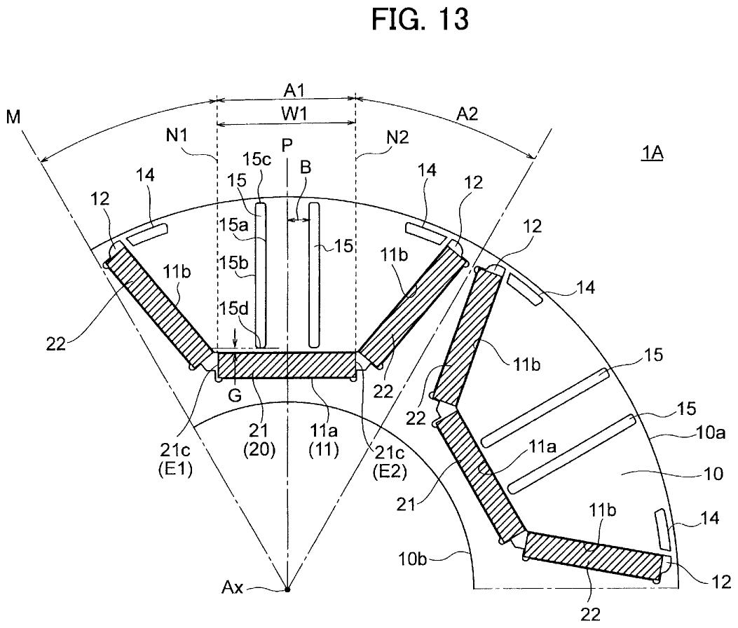

Next, a second embodiment will be described. FIG. 13 is a sectional view illustrating a part of a rotor 1A of the second embodiment. The rotor 1A of the second embodiment differs from the rotor 1 of the first embodiment in the arrangement of the slits 15.

Each magnetic pole region of the rotor 1A is divided into three regions in the direction perpendicular to the magnetic pole center line P. Of both the end surfaces 21c of the permanent magnet 21, one end surface 21c is defined as a first end portion E1, and the other end surface 21c is defined as a second end portion E2. A straight line passing through the first end portion E1 and parallel to the magnetic pole center line P is defined as a straight line N1. A straight line passing through the second end portion E2 and parallel to the magnetic pole center line P is defined as a straight line N2. The straight line N1 is also referred to as the first straight line, and the straight line N2 is also referred to as the second straight line.

A region sandwiched between the straight lines N1 and N2 in the circumferential direction is defined as a first region A1. The first region A1 has the same width as the width W1 of the permanent magnet 21. Meanwhile, each of a region between the straight line N1 and the inter-pole portion M and a region between the straight line N2 and the inter-pole portion M is defined as a second region A2.

The first region A1 is a region sandwiched between the permanent magnet 21 and the outer circumference 10a of the rotor core 10. The second region A2 is a region located on the outer side of the first region A1 in the circumferential direction.

In the second embodiment, the slits 15 are disposed within the first region A1. With this arrangement, the region between the slit 15 and the permanent magnet 22 disposed in the second hole portion 11b of the magnet insertion hole 11 is widened. Thus, the magnetic flux emitted from the permanent magnet 22 is less likely to cause magnetic saturation in this region.

The slit 15 is parallel to the magnetic pole center line P in this example. The shortest distance from the magnetic pole center line P to the end edge 15a of the slit 15 is denoted by B. Since the slits 15 are disposed within the first region A1, the shortest distance B is less than half the width W1 of the permanent magnet 21 (i.e., B<W1/2).

The shortest distance from the magnet insertion hole 11 to the slit 15 is denoted by G. The shortest distance G is the shortest distance from the first hole portion 11a of the magnet insertion hole 11 to the end edge 15d of the slit 15.

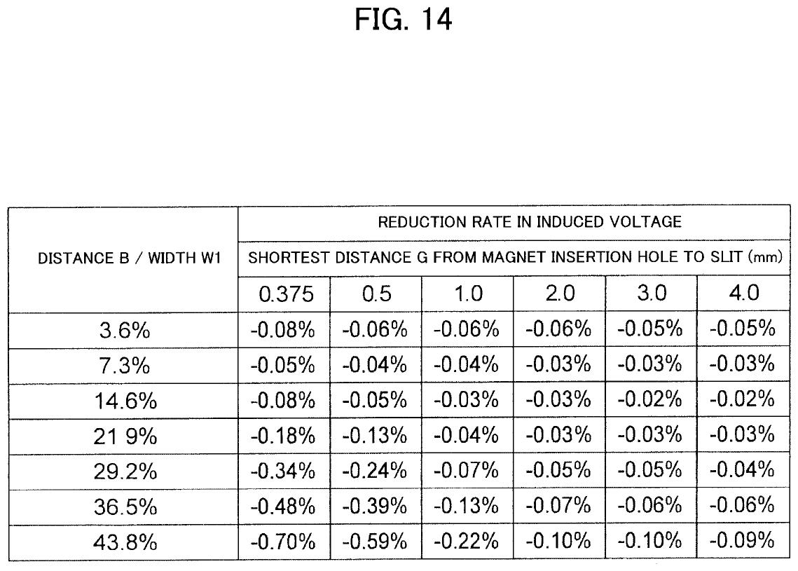

Here, description will be given on the desirable range of the ratio B/W1 of the shortest distance B from the magnetic pole center line P to the slit 15 to the width W1 of the permanent magnet 21. FIG. 14 is a table showing the results of analysis of changes in the induced voltage when the ratio B/W1 is varied.

The induced voltage is a voltage generated when the magnetic fluxes of the permanent magnets 21 and 22 interlink with the coils 55 of the stator 5. As the induced voltage increases, the motor output increases. FIG. 14 shows an amount of reduction in the induced voltage from a reference value which is defined as an induced voltage of the rotor 1C (FIG. 5) of Comparative Example having no slit 15.

In FIG. 14, the ratio B/W1 is varied to 3.6%, 7.3%, 14.6%, 21.9%, 29.2%, 36.5%, and 43.8%. In FIG. 14, the shortest distance G from the magnet insertion hole 11 to the slit 15 is also varied to 0.375 mm, 0.5 mm, 1.0 mm, 2.0 mm, 3.0 mm, and 4.0 mm.

As illustrated in FIG. 14, when the shortest distance G is set constant, the amount of reduction in the induced voltage increases as the value of B/W1 increases. This is because as the slit 15 recedes from the magnetic pole center line P, the slit 15 approaches to the second hole portion 11b of the magnet insertion hole 11, which makes the region between the slit 15 and the second hole portion 11b narrower, and causes magnetic flux concentration and subsequently magnetic saturation.

On the other hand, when the value of B/W1 is set constant, as the shortest distance G from the magnet insertion hole 11 to the slit 15 is made wider, the decrease in the induced voltage is suppressed more. This is because the magnetic flux can escape through a gap between the first hole portion 11a of the magnet insertion hole 11 and the slit 15 when magnetic flux concentration occurs in the region between the second hole portion 11b of the magnet insertion hole 11 and the slit 15.

As can be seen from FIG. 14, when B/W1 is 21.9% or less, the amount of reduction in the induced voltage can be suppressed within 0.2%, regardless of the value of the shortest distance G from the magnet insertion hole 11 to the slit 15. This is because magnetic saturation in the region between the second hole portion 11b of the magnet insertion hole 11 and the slit 15 is unlikely to occur when B/W1 is 21.9% or less.

Thus, the shortest distance B from the magnetic pole center line P to the slit 15 is desirably less than or equal to 21.9% of the width W1 of the permanent magnet 21. The shortest distance G from the magnet insertion hole 11 to the slit 15 only needs to be greater than or equal to the sheet thickness of each of the electromagnetic steel sheets constituting the rotor core 10.

Incidentally, when two permanent magnets 21 are disposed in the first hole portion 11a of the magnet insertion hole 11, the first region A1 is defined by straight lines N1 and N2 passing through the ends of the two permanent magnets 21 that are farthest from each other.

The slit 15 extends parallel to the magnetic pole center line P in this example, but may be inclined with respect to the magnetic pole center line P. In this case, it is desirable that at least the inner end of the slit 15 in the radial direction is located in the first region A1, while the shortest distance B from the magnetic pole center line P to the slit 15 is 21.9% or less of the width W1 of the permanent magnet 21.

Except for the above-described points, the rotor 1A of the second embodiment is configured in the same manner as the rotor 1 of the first embodiment.

As described above, in the second embodiment, the shortest distance B from the magnetic pole center line P to the slit 15 is less than or equal to 21.9% of the width W1 of the permanent magnet 21, and therefore the magnetic saturation is less likely to occur between the second hole portion 11b of the magnet insertion hole 11 and the slit 15. Thus, the demagnetization of the permanent magnet 22 can be suppressed without reducing motor output.

### Third Embodiment

Next, a third embodiment will be described. FIG. 15 is a sectional view illustrating a part of a rotor 1B of the third embodiment. The rotor 1B of the third embodiment differs from the rotor 1 of the first embodiment in the arrangement of the slits 15.

As described in the second embodiment, each magnetic pole region of the rotor 1B is divided into a first region A1 and second regions A2 on both sides of the first region A1. In the third embodiment, the slit 15 is formed in the second region A2.

The whole slit 15 is disposed within the second region A2 in this example. However, the slit 15 is not limited to such an arrangement, and it is sufficient that at least an inner end of the slit 15 in the radial direction is disposed within the second region A2.

In the third embodiment, the slit 15 extends while being inclined with respect to the magnetic pole center line P. More specifically, the slit 15 extends while being inclined in such a manner that the distance from the magnetic pole center line P increases toward the outer side in the radial direction.

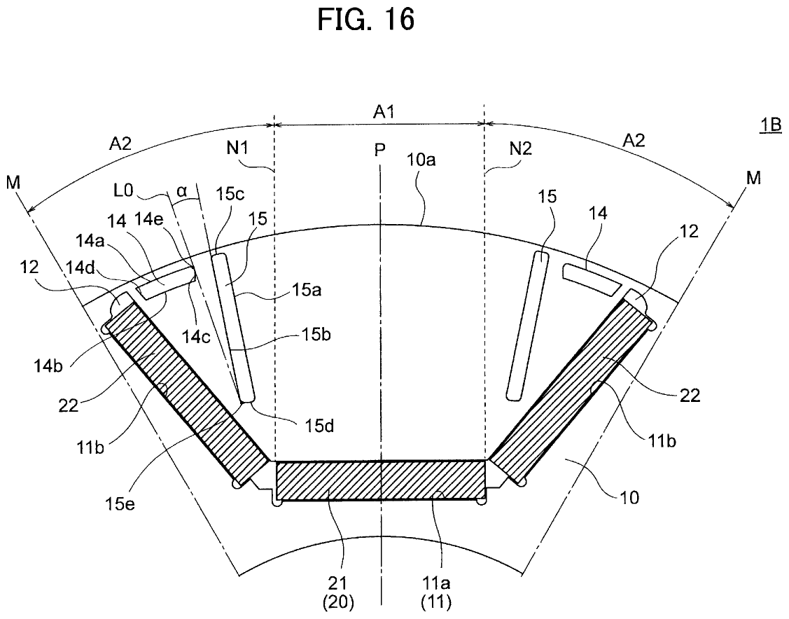

FIG. 16 is an enlarged diagram illustrating a part corresponding to one magnetic pole of the rotor 1B. The slit 15 has an end edge 15b facing the second hole portion 11b as described above. An inner end point of the end edge 15b in the radial direction is defined as a point 15e.

A point of the side slit 14 protruding closest to the magnetic pole center line P in the circumferential direction is defined as a point 14e. A straight line passing through the point 14e of the side slit 14 and the point 15e of the slit 15 is defined as a straight line L0. An angle formed between the end edge 15b of the slit 15 and the straight line L0 is defined as an angle α.

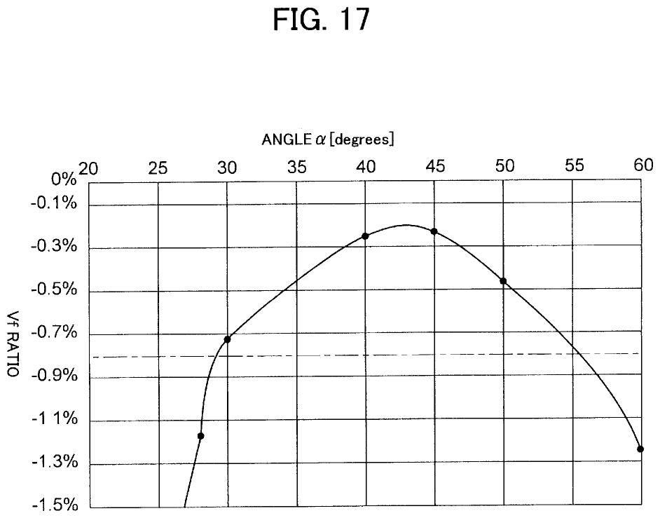

FIG. 17 is a graph showing changes in the Vf ratio when the angle α is varied. The Vf ratio is the ratio (V/f) of the output voltage (V) to the frequency (f). As the amount of magnetic flux interlinking with the coil 55 increases, the induced voltage increases, which makes the Vf ratio higher. FIG. 17 illustrates an amount of decrease in the Vf ratio from a reference value which is defined as the Vf ratio of the rotor 1C (FIG. 5) of Comparative Example having no slit 15.

As illustrated in FIG. 17, the amount of decrease in the Vf ratio can be suppressed to 0.8% or less when the angle α is within the range of 29 to 56 degrees. This is because, if the slit 15 is formed so that the angle α is between 29 and 56 degrees, the magnetic flux directed from the permanent magnets 21 and 22 toward the stator 5 is least blocked by the slit 15, and the flow of the magnetic flux is made smooth. Because of this, by setting the angle α to be within 29 to 56 degrees, the motor output can be improved.

A case where the number of poles of the rotor 1B is six has been described, but the number of poles of the rotor 1B is not limited to six. As the number of poles of the rotor 1B increases, the spread angle of the magnetic flux per magnetic pole decreases. Thus, when the above results are applied to the rotor 1B in which the number of poles is N (N is a natural number), the desirable range of the angle α formed between the end edge 15b of the slit 15 and the straight line L0 is 29×N/6≤α≤56×N/6.

As described above, in the third embodiment, the angle α formed between the end edge 15b of the slit 15 facing the second hole portion 11b and the straight line L0 passing through the inner end point (point 15e) of the end edge 15b in the radial direction and the point 14e of the side slit 14 located closest to the magnetic pole center line P is within the range of 29×N/6≤α≤56×N/6. Thus, the flow of the magnetic flux from the permanent magnets 21 and 22 toward the stator 5 can be made smooth, thus improving the motor output.

### (Compressor)

Next, the compressor 500 to which the motors of the first to third embodiments are applicable will be described. FIG. 18 is a longitudinal-sectional view illustrating the compressor 500 to which the motors of the first to third embodiments are applicable. The compressor 500 is a scroll compressor in this example, but is not limited thereto.

The compressor 500 has the motor 100, a compression mechanism 501 coupled to one end of the shaft 30 of the motor 100, a subframe 503 supporting the other end of the shaft 30, and the hermetic container 502 in which these components are housed. Refrigerant oil 504 is stored in an oil reservoir 505 at the bottom of the hermetic container 502.

The compression mechanism 501 includes a fixed scroll 511, an oscillating scroll 512, an Oldham ring 513, a compliant frame 514, and a guide frame 515. The fixed scroll 511 and the oscillating scroll 512 both have plate-shaped spiral teeth and are combined to form a compression chamber 516.

The fixed scroll 511 has a discharge port 511a through which the refrigerant compressed in the compression chamber 516 is discharged. A suction pipe 506 that penetrates the hermetic container 502 is press-fitted into the fixed scroll 511. A discharge pipe 507 is provided to penetrate the hermetic container 502. Through the discharge pipe 507, a high-pressure refrigerant gas discharged from the discharge port 511a of the fixed scroll 511 is discharged to the outside.

The motor 100 is incorporated inside the hermetic container 502 by shrink-fitting. Glass terminals 508 for electrically connecting the stator 5 of the motor 100 with a drive circuit is fixed to the hermetic container 502 by welding.

The operation of the compressor 500 is as follows. When the motor 100 rotates, the shaft 30 rotates with the rotor 1. As the shaft 30 rotates, the oscillating scroll 512 oscillates, thereby changing the volume of the compression chamber 516 between the fixed scroll 511 and the oscillating scroll 512. Thus, the refrigerant gas is drawn into the compression chamber 516 through the suction pipe 506 and compressed therein.

The high-pressure refrigerant gas compressed in the compression chamber 516 is discharged from the discharge port 511a of the fixed scroll 511 into the hermetic container 502 and then discharged to the outside through the discharge pipe 507. Part of the refrigerant gas discharged from the compression chamber 516 into the hermetic container 502 passes through holes provided in the motor 100 to cool the motor 100.

The motor 100 described in each embodiment has high motor efficiency due to the suppression of demagnetization of the permanent magnet 22. Therefore, the operating efficiency of the compressor 500 can be improved by using the motor 100 as a drive source for the compressor 500.

### (Refrigeration Cycle Apparatus)

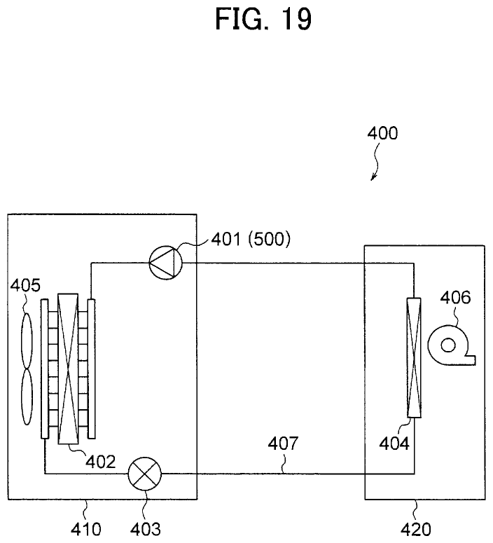

Next, a refrigeration cycle apparatus 400 including the compressor 500 illustrated in FIG. 18 will be described. FIG. 19 is a diagram illustrating a configuration of the refrigeration cycle apparatus 400. The refrigeration cycle apparatus 400 includes a compressor 401, a condenser 402, a throttle device (decompressor) 403, and an evaporator 404.

The compressor 401, the condenser 402, the throttle device 403, and the evaporator 404 are coupled together by a refrigerant pipe 407 to constitute a refrigeration cycle. That is, the refrigerant circulates through the compressor 401, the condenser 402, the throttle device 403, and the evaporator 404 in this order.

The compressor 401, the condenser 402, and the throttle device 403 are provided in an outdoor unit 410. The compressor 401 is constituted by the compressor 500 illustrated in FIG. 18. The outdoor unit 410 is provided with an outdoor fan 405 that supplies the outdoor air to the condenser 402. The evaporator 404 is provided in an indoor unit 420. The indoor unit 420 is provided with an indoor fan 406 that supplies air cooled by the evaporator 404 indoors.

The operation of the refrigeration cycle apparatus 400 is as follows. The compressor 401 compresses the drawn refrigerant, and sends out the compressed refrigerant. The condenser 402 exchanges heat between the refrigerant flowing in from the compressor 401 and the outdoor air to condense and liquefy the refrigerant and sends out the refrigerant to the refrigerant pipe 407. The outdoor fan 405 supplies the outdoor air to the condenser 402. The throttle device 403 decompresses the refrigerant flowing through the refrigerant pipe 407 to bring it into a low pressure state.

The evaporator 404 exchanges heat between the refrigerant decompressed by the throttle device 403 and the indoor air to evaporate the refrigerant and sends out the refrigerant to the refrigerant pipe 407. The cool air cooled by the heat exchange in the evaporator 404 is supplied indoors by the indoor fan 406.

The refrigeration cycle apparatus 400 has the compressor 401 whose operating efficiency is improved by employing the motor 100 described in each embodiment. Thus, the operating efficiency of the refrigeration cycle apparatus 400 can be improved.

Although the desired embodiments have been specifically described, various modifications and changes can be made thereto based on the above embodiments.

1. A rotor comprising:
a rotor core having an outer circumference extending in a circumferential direction about an axis and a magnet insertion hole disposed on an inner side of the outer circumference in a radial direction about the axis; and
at least three permanent magnets disposed in the magnet insertion hole,
wherein the magnet insertion hole has a first hole portion located at a center of the magnet insertion hole in the circumferential direction, and two second hole portions extending from both ends of the first hole portion in the circumferential direction toward the outer circumference,
wherein the at least three permanent magnets comprise a first permanent magnet disposed in the first hole portion and a second permanent magnet disposed in each of the second hole portions,
wherein the first hole portion extends in a direction perpendicular to a magnetic pole center line that extends in the radial direction and passes through a center of the magnet insertion hole in the circumferential direction,
wherein the rotor core has:
a first slit formed between each of the second hole portions and the magnetic pole center line and having a length in the circumferential direction; and
a second slit formed between the first slit and the magnetic pole center line and having a length in the radial direction, and
wherein a shortest distance C [mm] from the first slit to the magnet insertion hole and a shortest distance S [mm] from the first slit to the outer circumference satisfy:
$$S \leq - 0.7517 {C}^{2} + 0.2021 C + 1 \text{.1395} .$$

2. The rotor according to claim 1, wherein the rotor core is formed of a plurality of electromagnetic steel sheets that are stacked in a direction of the axis, and
wherein the shortest distance S is greater than or equal to a sheet thickness T of each of the electromagnetic steel sheets.

3. The rotor according to claim 1, wherein a shortest distance B from the magnetic pole center line to the second slit and an interval W1 between both ends of the first permanent magnet in the circumferential direction satisfy B≥W1×½.

4. The rotor according to claim 1, wherein a shortest distance B [mm] from the magnetic pole center line to the second slit and an interval W1 [mm] between both ends of the first permanent magnet in the circumferential direction satisfy B<0.219×W1.

5. The rotor according to claim 4, wherein two straight lines parallel to the magnetic pole center line and passing through both ends of the first permanent magnet in the circumferential direction are defined as a first straight line and a second straight line,
wherein the rotor core has a first region sandwiched between the first straight line and the second straight line in the circumferential direction and a second region located on an outer side of the first region in the circumferential direction,
wherein at least an inner end of the second slit in the radial direction is disposed within the second region, and
wherein when an angle formed between an end edge of the second slit facing the second hole portion and a straight line passing through an inner end point of the end edge in the radial direction and a point of the first slit closest to the magnetic pole center line is denoted by α [degrees] and a number of poles of the rotor is denoted by N,
29×N/6≤α≤56×N/6 is satisfied.

6. The rotor according to claim 4, wherein the second slit extends while being inclined with respect to the magnetic pole center line in such a manner that a distance from the magnetic pole center line increases toward an outer side in the radial direction.

7. The rotor according to claim 1, wherein the second slit extends parallel to the magnetic pole center line.

8. The rotor according to claim 1, wherein a length L1 of the first slit and a length L2 of the second slit satisfy L2/L1≥0.426.

9. The rotor according to claim 1, wherein the rotor core is formed of a plurality of electromagnetic steel sheets that are stacked in a direction of the axis,
wherein a thin-walled portion is formed between the second slit and the outer circumference of the rotor core, and
wherein a width of the thin-walled portion in the radial direction is the same as a sheet thickness of each of the electromagnetic steel sheets.

10. A motor comprising:
the rotor according to claim 1; and
a stator surrounding the rotor from outside in the radial direction.

11. A compressor comprising:
the motor according to claim 10; and
a compression mechanism driven by the motor.

12. A refrigeration cycle apparatus comprising:
the compressor according to claim 11;
a condenser to condense refrigerant sent out from the compressor;
a decompressor to decompress the refrigerant condensed by the condenser; and
an evaporator to evaporate the refrigerant decompressed by the decompressor.

13. The rotor according to claim 1, wherein the first hole portion and the second hole portion of the magnet insertion hole are formed continuously with each other.
